(19) United States
(12) Patent Application Publication
(10) Pub. No.: US 2013/0128189 A1
(43) Pub. Date: May 23, 2013

(54) Backlight Module and Liquid Crystal Display Device

(71) Applicants: Chechang Hu, Shenzhen (CN); Hu He, Shenzhen (CN)

(72) Inventors: Chechang Hu, Shenzhen (CN); Hu He, Shenzhen (CN)

(21) Appl. No.: 13/379,078

(22) PCT Filed: Dec. 2, 2011
(86) PCT No.: PCT/CN11/83337

§ 371 Date: Dec. 19, 2011

(30) Foreign Application Priority Data
Nov. 21, 2011 (CN) 201110371580.1

(51) Int. Cl. G02F 1/13357; F21V 7/00; F21V 8/00

(52) U.S. Cl. 349/65; 362/611; 362/613; 362/609

(57) ABSTRACT

The present invention discloses a backlight module and an LCD device, wherein the backlight module comprises a light bar, a light guide plate coupled to a luminous surface of the light bar, and a coupling light element arranged between the light bar and the light guide plate; and the coupled light element forms a coupled light channel faced to a light incident surface of the light guide plate around the luminous surface of the light bar. The present invention, by arranging the coupling light element between the luminous surface of the light bar and the light guide plate of the backlight module to be used for leading the light emitted by the light bar to the light guide plate, make the coupling light element formed the coupling light channel faced to the light incident surface of the light guide plate around the luminous surface of the light bar. Besides, the coupling light channel leads the light emitted by the light bar to the light incident surface of the light guide plate, and especially to reflect the wide-angle rays emitted by the light bar to the light incident surface of the light guide plate, and then to make the light emitted by the light bar entered into the light guide plate as much as possible. In this arrangement, the utilization rate of rays of the light emitting lamps is enhanced, the efficiency of the backlight module is enhanced and the display effect of an LCD device is improved.

### TECHNICAL FIELD

The present invention relates to the field of liquid crystal displays, and more particularly to a backlight module and a liquid crystal display (LCD) device.

### BACKGROUND

The backlight module is a crucial component of the LCD device and can provide a light source for the LCD device, so that the LCD device can display images.

At present, the backlight module mainly uses the CCFL (Cold Cathode Fluorescent Tube), the LED (Light Emitting Diode), the EL (Electro Luminescent) and other light sources. The edge-lit LCD device has been accepted by the merchants with the advantages of light weight and thin body. Taking the backlight module for LCD device with the LED light source for example, as shown in FIG. 1, the backlight module is composed of a reflector plate 1, a light guide plate 2, a rubber frame 4, a reflecting layer 3 arranged on the rubber frame 4, a PCB board 5, the LEDs 6, an aluminum extrusion part 7, a backplane 8, etc. Wherein, the LEDs 6 are the light sources, and the function of the light guide plate is to conduct light and adjust the similar point light sources of the LEDs 6 as the plane light sources. Besides, the coupling efficiency of the LEDs 6 and the light guide plate 1 is directly related to the efficiency of the whole backlight module and the utilization rate of light; at present, the Lambert LED, approximated to a light-emitting form, are usually be used. The distribution of the light-emitting angle of the existing LEDs is as shown in FIG. 2, the light emitted by the LEDs concentrates on the front-view angle. When the angle is wider to a certain extent, the number of rays in this angle is also lessened and the spatial distribution is confined to a finite angle. A 5630 LED package is as shown in FIG. 3, the size of the package is 5.6 mm*3.0 mm*0.8 mm. The luminous flux of different visual angles is measured in the horizontal and vertical directions. In accordance with the curve, it is observed that the luminous flux has been reduced by a half when the visual angle is approximately 60°, that is, the wider visual angle has a less luminous flux.

When the light of the LEDs is coupled to that of the LGP, usually, a coupling light distance will exist between the light incident surface of the light guide plate and the surface of the LEDs, so as to avoid the light guide plate directly contacting the LEDs. The size of the coupling light distance can vary according to the body types. Taking the coupling of the 5630 LED package and the light guide plate with the thickness of 3.0 mm for example, the vertical distance of the luminous surface of the 5630 package is 2.4 mm. Only from the light-emitting form of the LED, the coupling light distance is shorter and the proportion of light leakage is smaller. As shown in FIG. 4 and FIG. 5, under two coupled light-distances, the rays emitted by the LEDs 6 will be leaked in a light leakage region 21 which is in the region with a wider visual angle of the LEDs 6. The luminous flux in the region is less, but the influence on the efficiency of the backlight module is larger, and even to affect the display effect of the LCD device. The coupling light distance between the LEDs 6 and the light guide plate 2 as shown in FIG. 4 is greater than that of as shown in FIG. 5. As shown in FIG. 3, in accordance with the analysis for the illumination angle of the 5630 LED, the mode as shown in FIG. 5 has a less extent of light leakage, but the light leakage still exists here. In order to make full use of the missing rays, the backlight module is usually provided with some returnable assemblies. As shown in FIG. 1, the reflection layer 3 is arranged on the bottom of the rubber frame 4, so that the missing rays are reflected to the light guide plate 2 and the reflector plate 1. But, there is a gap between the reflector plate 1 and the light guide plate 2, partial rays are still missed, especially when the coupling light distance is larger.

### SUMMARY

The aim of the present invention is to provide a backlight module with high efficiency and an LCD device with nice display effect.

The aim of the present invention is achieved by the following technical schemes. A backlight module comprises a light bar, a light guide plate, and a coupling light element, wherein the light guide plate is coupled to the luminous surface of the light bar; the coupling light element is arranged between the light bar and the light guide plate; and the coupling light element forms a coupling light channel faced to the light incident surface of the light guide plate around the luminous surface of the light bar.

Preferably, the luminous surface of the light bar is closed by an opening of the coupling light channel to avoid the wide-angle rays of the luminous surface leaking light.

Preferably, the opening end of the coupling light channel is not smaller than the luminous surface of the light bar, which the wide-angle rays emitted by the light bar pass through the coupling light channel.

Preferably, the depth of the coupling light channel coincides with the distance from the light incident surface of the light guide plate to the luminous surface of the light bar. The coupling light channel is directly connected to the light incident surface of the light guide plate. The coupling light channel forms a closed channel between the light incident surface of the light guide plate and the luminous surface of the light bar. Thus, the light leakage can be avoided and the higher effect of using rays is achieved.

Preferably, the width of the end of the coupling light channel is less than or equal to the thickness of the light guide plate so as to avoid leaking out the light leakage by oversize width of the end and reduce the utilization rate of the rays.

Preferably, the width of the luminous surface of the light bar is less than the thickness of the light guide plate, the opening end of the coupling light channel is smaller than the end opening of the channel, and the cross section of the coupling light channel is in a cone-shape. For this mode, the coupling light channel in the corresponding cone-shape can be provided, so that the rays can enter into the light guide plate without leakage.

Preferably, the width of the luminous surface of the light bar is greater than the thickness of the light guide plate, the beginning opening of the coupling light channel is bigger than the end opening of the channel, and the cross section of the coupling light channel is in an inverted cone-shape. For this mode, the coupling light channel in the corresponding inverted cone-shape can be provided, so that the rays can enter into the light guide plate without leakage.

Preferably, the light bar comprises multiple light emitting lamps arranged side by side; the coupling light element has multiple coupling light channels which correspond to each luminous surface of the light emitting lamp. One coupling light element can simultaneously correspond to multiple light emitting lamps to facilitate producing the coupling light element and improving the efficiency during assembling.

Preferably, the light bar comprises multiple light emitting lamps arranged side by side. Each light emitting lamp is provided with one corresponding coupling light element to facilitate replacing the damaged light emitting element.

Preferably, the interior surface of the coupling light channel is a smooth reflecting surface after polishing treatment. The smooth reflecting surface contributes to that the rays reflect to one direction without the diffuse-reflection. Thus, the rays are lost in repeated diffuse-reflections to enhance the utilization rate of ray.

Preferably, the smooth reflecting surface is a curved surface of focusing rays. In order to focus the rays, reduce the number of reflection and reduce the loss of the rays, the smooth reflecting surface is manufactured into a smooth curved surface.

Preferably, the interior surface of the coupling light channel is polished. Thus, the interior surface of coupling light channel is super smooth after the polishing treatment to enhance the reflectivity of light.

Preferably, the coupling light element is installed on the light bar in the production process of the light bar so as to facilitate mounting in later stage and enhance the production efficiency.

Preferably, the light bar comprises multiple light emitting lamps and a PCB board, wherein the light emitting lamps are arranged side by side; the PCB board is used to mount the light emitting lamps; and the coupling light element is installed on the package of the light emitting lamps. This arrangement structure of the coupling light element is relatively simple and can save the materials.

Preferably, the light bar comprises multiple light emitting lamps and a PCB board, wherein the light emitting lamps are arranged side by side; the PCB board is used to mount the light emitting lamps; the coupling light element is installed on the PCB board of the light bar; the coupling light element is provided with the mounting hole that matches with the shape of the light emitting lamps; the mounting hole is connected to the coupling light channel; and the size of the mounting hole is greater than or equal to the area of the beginning opening of the coupling light channel. The coupling light element is arranged on the PCB board to avoid the phenomenon that the light guide plate extrudes the coupling light element to bump into the light emitting lamps after being heated and expanded.

Preferably, the coupling light element corresponding to each light emitting lamp has a ladder-shaped groove, wherein the mounting hole is the first level groove of the ladder-shaped groove; the coupling light channel is the second level groove of the ladder-shaped groove. This arrangement structure makes the mounting and positioning of the coupling light element more reliable.

Preferably, the coupling light element is made of metal or plastic materials. The metal material has excellent reflecting capability, while the cost of the plastic material is lower.

An LCD device comprises any one of the aforementioned backlight modules of Claims.

The present invention, by arranging a coupling light element between a luminous surface of a light bar and a light guide plate of a backlight module to be used for leading the light emitted by the light bar to the light guide plate, make the coupling light element formed a coupling light channel faced to a light incident surface of the light guide plate around the luminous surface of the light bar. Besides, the coupling light channel leads the light emitted by the light bar to the light incident surface of the light guide plate, and especially to reflect the wide-angle light emitted by the light bar to the light incident surface of the light guide plate, and then to make the light emitted by the light bar entered into the light guide plate as much as possible. In this arrangement, the utilization rate of ray of the light emitting lamps is enhanced, the efficiency of the backlight module is enhanced and the display effect of an LCD device is improved.

### BRIEF DESCRIPTION OF FIGURES

FIG. 1 is a simplified structure diagram of an existing backlight module;

FIG. 2 is a distribution table of the light angle illuminated by a Lambert LED;

FIG. 3 is a distribution table of the light angle illuminated by a 5630 LED;

FIG. 4 is diagram of the situation of receiving LED rays by a light guide plate in one coupling light distance;

FIG. 5 is diagram of the situation of receiving LED rays by a light guide plate in another coupling light distance;

FIG. 6 is the first embodiment of the present invention;

FIG. 7 is a coupling light element in the first embodiment of the present invention;

FIG. 8 is a matching situation of the coupling light element and the LED in the first embodiment of the present invention;

FIG. 9 is the second embodiment of the present invention;

FIG. 10 is a schematic diagram of matching a coupling light element in the second embodiment of the present invention;

FIG. 11 is a simplified structure diagram of a coupling light element after assembly in the second embodiment of the present invention;

FIG. 12 is a principle drawing of the present invention;

FIG. 13 shows a coupling light element used when using a 7020 LED and a 3.00 mm thickness of light guide plate as well as its matching form;

FIG. 14 shows a coupling light element used when using a 5630 LED and a 3.00 mm thickness of light guide plate as well as its matching form;

FIG. 15 shows a coupling light element used when using a 5630 LED and a 2.00 mm thickness of light guide plate as well as its matching form;

FIG. 16 is one assembly form of a coupling light element;

FIG. 17 is another assembly form of a coupling light element;

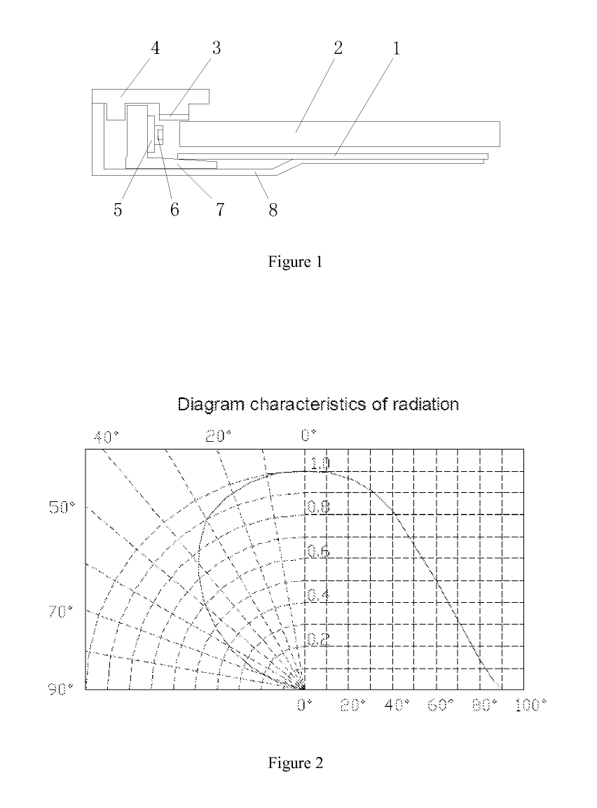

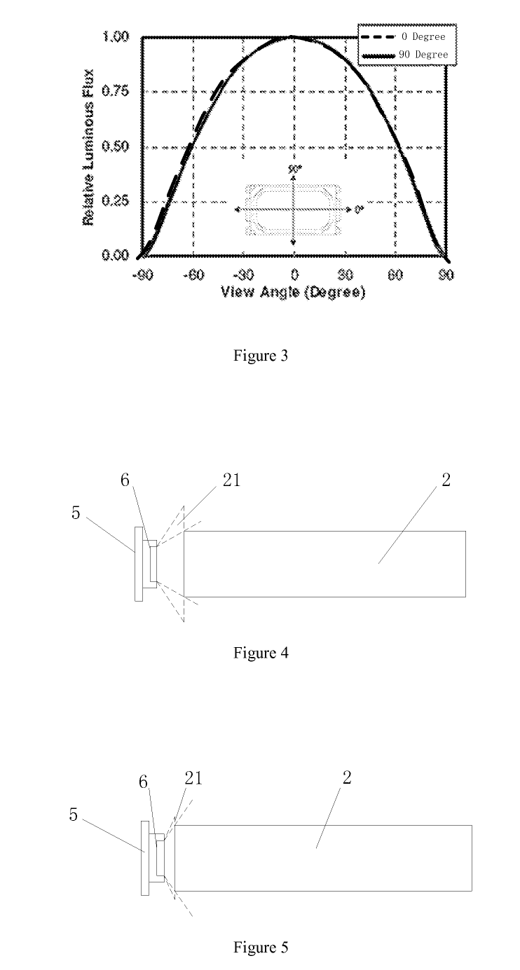

Wherein:
1. reflector plate; 2. light guide plate; 3. reflection layer; 4. rubber frame; 5. PCB board; 6. LED; 7. aluminum extrusion part; 8. backplane; 21. light leakage region; 60. coupling light element; 61. coupling light channel; 62. smooth reflecting surface.

### DETAILED DESCRIPTION

The present invention will further be described in detail in accordance with the figures and the preferred embodiments.

A backlight module of the present invention comprises a light bar for providing the light source and a light guide plate coupled to the luminous surface of the light bar; besides a coupling light element is arranged between the light bar and the light guide plate to be used for leading the light emitted by the light bar to the light guide plate; and the coupling light element has a coupled light channel that protrudes out of the luminous surface of the light bar and is bigger than the luminous surface. The coupling light channel leads the light emitted by the light bar to the light incident surface of the light guide plate, and especially to reflect the wide-angle light emitted by the light bar to the light incident surface of the light guide plate, and then to make the light emitted by the light bar entered into the light guide plate as much as possible. In this arrangement, the utilization rate of ray of the LEDs is enhanced, the efficiency of the backlight module is enhanced and the display effect of an LCD device is improved.

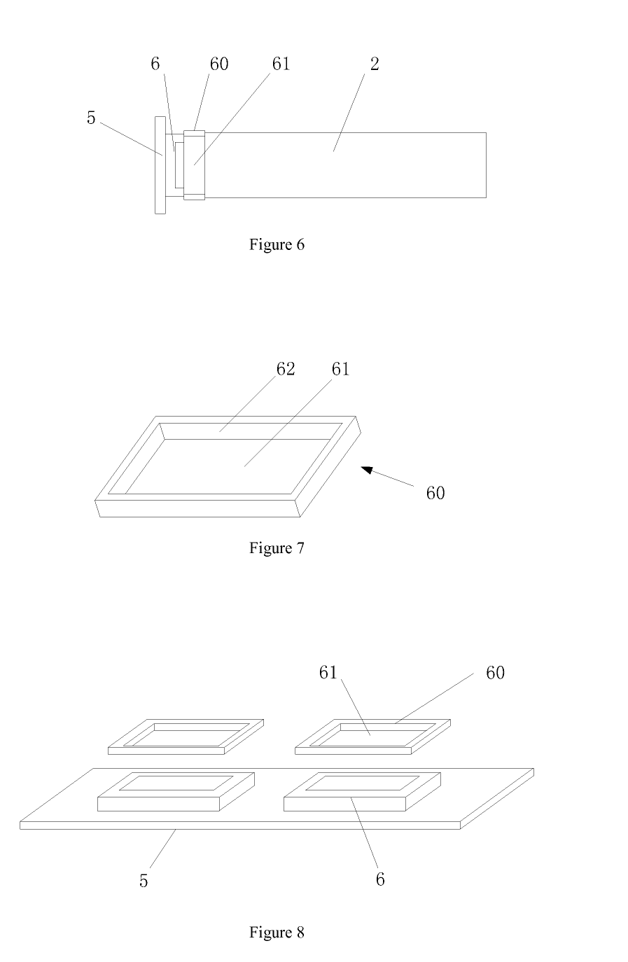

The first embodiment of the present invention is as shown in FIG. 6, taking the existing LED light bar used for many times for example, the LED light bar comprises a PCB board 5 and multiple LEDs 6 that are arranged on the PCB board side by side. Wherein, a coupling light element 60 is arranged between the light guide plate 2 and the LED light bar, as shown in FIG. 7, the coupling light element 60 is a square frame in which the square hollow region is a coupling light channel 61; as shown in FIG. 6, the opening of the coupling light channel 61 starts from the luminous surface of the LEDs 6; and the beginning opening surface of the coupling light channel 61 is greater than the luminous surface of the LEDs 6. Thus, the light emitted by the LEDs 6 can be leaded into the coupling light channel 61. The end of the coupling light channel 61 is fully coupled to the light incident surface of the light guide plate 2 and its width is less than the thickness of the light guide plate 2, that is, the end opening surface of the coupling light channel 61 is completely in the light incident surface of the light guide plate. Thus, the coupling light element 60 forms a closed space between the light guide plate 2 and the LEDs 6 to ensure that there is no light leakage before entering into the light guide plate. Besides, as shown in FIG. 7, the interior surface of the coupling light channel 61 is a smooth reflecting surface after the polishing treatment, so as to avoid the interior surface absorbing light. The wide-angle rays of the LEDs 6 can be reflected to the light guide plate 2 within the smooth reflecting surface 62. Of course, the rays that are reflected back by the light incident surface of the light guide plate 2 are also reflected to back again through the closed coupling light channel 61 and the smooth reflecting surface 62 to achieve the higher utilization rate of ray.

In this embodiment, the width of end opening surface of the coupling light channel also equals to or approximately equals to the thickness of the light guide plate 2, so that the larger end opening can be obtained as widely as possible, the ray is reflected at minimum times, and the phenomena that the ray is absorbed by the interior surface of the coupling light channel 61 during reflecting.

In this embodiment, as shown in FIG. 8, each LED 6 on LED light bars is correspondingly provided with a separate coupling light element 60; and the shape of the outer frame of each coupling light element 60 corresponds to the shape of the package structure outside of the luminous surface of each LED 6.

In this embodiment, the interior surface of the coupling light channel 61, i.e. the smooth reflecting surface, is manufactured into a smooth curved surface in snoot-shape, so as to focus the rays, reduce the number of reflection and reduce the loss of the rays.

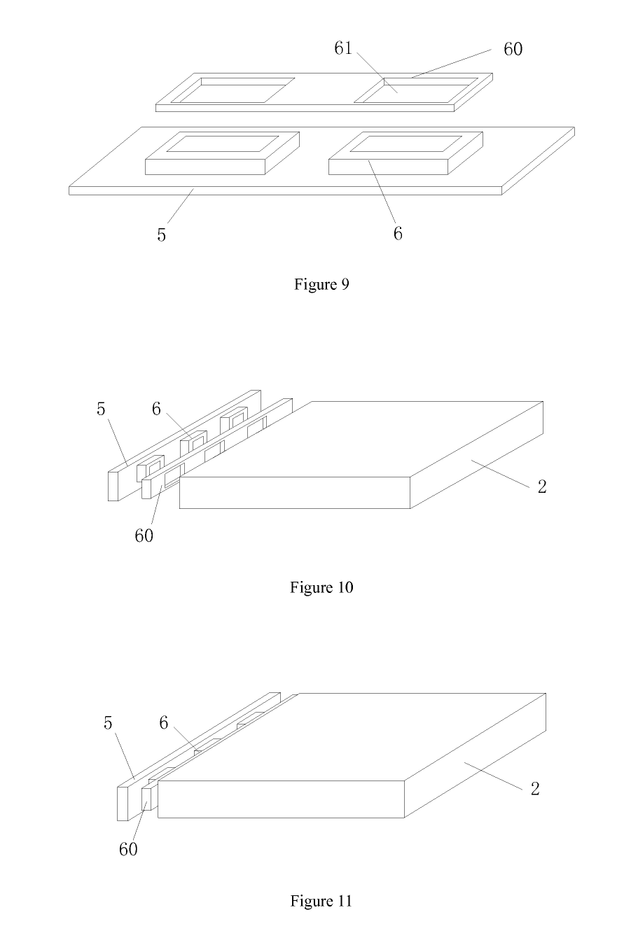

The second embodiment of the present invention is as shown in FIG. 9 to FIG. 11, unlike the first embodiment, in this embodiment, the coupling light element 60 is a whole part which has multiple coupling light channels 61 corresponding to each LED 6 (as shown in FIG. 9). This coupling light element can facilitate assembling, reduce the time required for assembly, facilitate producing the coupling light element and increase the production efficiency. As shown in FIG. 10 and FIG. 11, the coupling light element 60 will be arranged between the LED light bar and the light guide plate as a whole. And each coupling light channel 61 on the coupling light element corresponds to each LED 6 on the LED light bar.

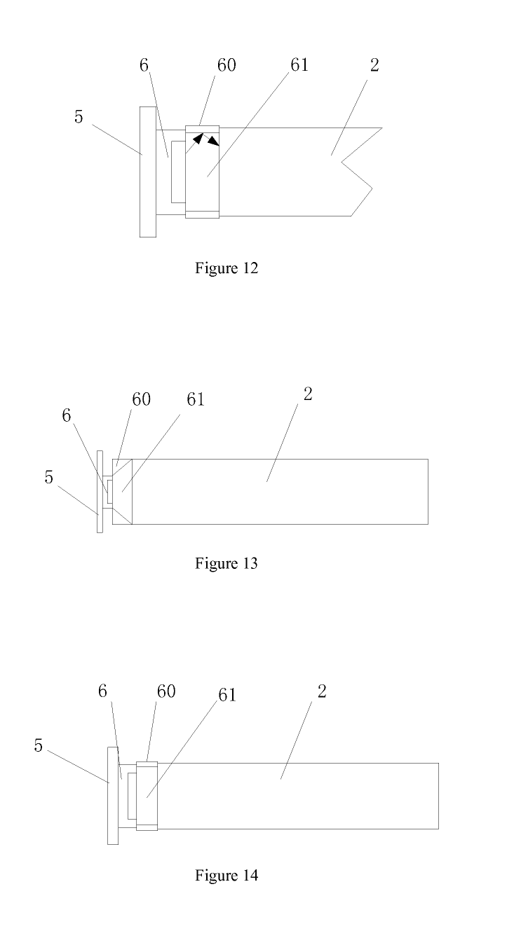

The reflection case of the rays emitted by the LEDs 6 within the coupling light channel 61 of the present invention is as shown in FIG. 12, the black arrow expresses the direction of reflecting the rays. From FIG. 12, it is observed that the wide-angle rays emitted by the LEDs 6 will be reflected to the light guide plate 2 through the interior surface of the coupling light channel 61; simultaneously, the coupling light element 60 forms a closed space between the light guide plate 2 and the LEDs 6 to avoid the light leakage.

In the backlight module, the size of the LEDs will vary with the type used. Besides, the light guide plate also has different thickness specifications, in accordance with the LEDs and the light guide plate with different specifications, the coupling light element with corresponding shapes, comprising the shape of the coupling light channel, can be provided to make full use of the rays.

FIG. 13 shows a coupling light element used when using a 7020 LED and a 3.00 mm thickness of light guide plate as well as its matching form; in this type, the whole size of the coupling light element 60 meets the light guide plate and has a coupling light channel 61 with a conical section; the beginning opening of the coupling light channel 61 meets or is more than the size of the luminous surface of the LEDs 6; the width of the end opening equals to the thickness of the light guide plate 2. In this arrangement, it can ensure that the LEDs 6 will not leak light and the number of reflections is the minimum.

FIG. 14 shows a coupling light element used when using a 5630 LED and a 3.00 mm thickness of light guide plate as well as its matching form. In this arrangement, the width of the 5630 LED 6 equals to the thickness of the light guide plate 2, so the coupling light channel of the coupling light element 60 can have a square section.

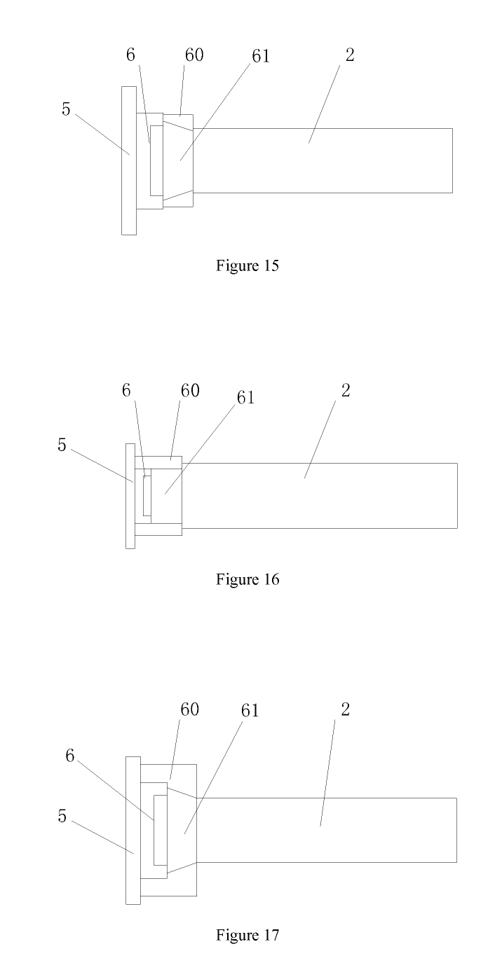

FIG. 15 shows a coupling light element used when using a 5630 LED and a 2.00 mm thickness of light guide plate as well as its matching form. Because the thickness of the light guide plate 2 is less than the width of the LED 6, the coupling light channel 61 of the coupling light element 60 can have a section in inverted cone-shape.

FIG. 16 is an arrangement form of the coupling light element, in the figure, one end of the coupling light element 60 can be arranged on the PCB board 5 to avoid the phenomenon that the light guide plate extrudes, after being heated and expanded, the coupling light element 60 and to extrude the package structure of the LEDs 6. At the same time, this structure facilitates adding the coupling light element in the production process of the light bar and is convenient to do subsequent installation work.

FIG. 17 shows the designs of the coupling light channels that are provided for the coupling light element arranged on the PCB board and the different thickness of light guide plate. As shown in FIG. 17, the coupling light element 60 is provided with the ladder-shaped groove, wherein the LEDs 6 are plunged into the first level groove of the ladder-shaped groove; while the conical section area is the second level groove, i.e. the coupling light channel 61. In this way, the coupling light element can be installed on the PCB board to enhance the positioning reliability of the coupling light element.

Under both conditions are as shown in FIG. 16 and FIG. 17, the coupling light element can be directly added in the process of producing the LED light bar to form a whole assembly to facilitate assembling in later stage.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

1. A backlight module, comprising: a light bar, a light guide plate, and a coupling light element, wherein the light guide plate is coupled to a luminous surface of the light bar; the coupling light element is arranged between the light bar and the light guide plate; and the coupled light element forms a coupling light channel faced to a light incident surface of the light guide plate around the luminous surface of the light bar.

2. The backlight module of claim 1, wherein said luminous surface of the light bar is closed by an opening of said coupling light channel.

3. The backlight module of claim 2, wherein the beginning opening of said coupling light channel is not smaller than the luminous surface of said light bar.

4. The backlight module of claim 3, wherein the depth of said coupling light channel coincides with the distance from the light incident surface of said light guide plate to the luminous surface of said light bar; and said coupling light channel is directly connected to the light incident surface of the light guide plate.

5. The backlight module of claim 4, wherein the end width of said coupling light channel is less than or equal to the thickness of said light guide plate.

6. The backlight module of claim 5, wherein the width of the luminous surface of said light bar is less than the thickness of said light guide plate, the beginning opening of said coupling light channel is smaller than the end opening thereof, and the cross section of said coupling light channel is in a cone-shape.

7. The backlight module of claim 5, wherein the width of the luminous surface of said light bar is greater than the thickness of said light guide plate, the beginning opening of said coupling light channel is bigger than the end opening thereof, and the cross section of said coupling light channel is in an inverted cone-shape.

8. The backlight module of claim 1, wherein said light bar comprises multiple light emitting lamps arranged side by side, said coupling light element has multiple coupling light channels corresponding to each luminous surface of said light emitting lamps.

9. The backlight module of claim 1, wherein said light bar comprises multiple light emitting lamps arranged side by side, and each light emitting lamp is provided with one corresponding coupling light element.

10. The backlight module of claim 1, wherein the interior surface of said coupling light channel is a smooth reflecting surface.

11. The backlight module of claim 10, wherein said smooth reflecting surface is a curved surface that can lead the rays to the light incident surface of the light guide plate.

12. The backlight module of claim 10, wherein the interior surface of said coupling light channel is polished.

13. The backlight module of claim 1, wherein said coupling light element is installed on said light bar in the production process of said light bar.

14. The backlight module of claim 13, wherein said light bar comprises multiple light emitting lamps arranged side by side and a PCB board for mounting the light emitting lamps; and said coupling light element is installed on the package of said light emitting lamps.

15. The backlight module of claim 13, wherein said light bar comprises multiple light emitting lamps arranged side by side and a PCB board for mounting said light emitting lamps; the coupling light element is installed on the PCB board of said light bar; said coupling light element is provided with a mounting hole that matches with the shape of said light emitting lamps; said mounting hole is connected to said coupling light channel; and the size of said mounting hole is greater than or equal to the area of the beginning opening of said coupling light channel.

16. The backlight module of claim 15, wherein said coupling light element corresponding to each light emitting lamp has a ladder-shaped groove; said mounting hole is the first level groove of said ladder-shaped groove; and said coupling light channel is the second level groove of said ladder-shaped groove.

17. The backlight module of claim 1, wherein said coupling light element is made of metal or plastic materials.

18. An LCD device comprises the backlight module of claim 1, wherein said backlight module comprises a light bar, a light guide plate coupled to a luminous surface of the light bar and a coupling light element arranged between the light bar and the light guide plate; and said coupled light element forms a coupling light channel faced to a light incident surface of said light guide plate around the luminous surface of the light bar.

19. The LCD device of claim 18, wherein the luminous surface of said light bar is closed by the opening of said coupling light channel.

20. The LCD device of claim 19, wherein the beginning opening of said coupling light channel is not smaller than the luminous surface of said light bar.

21. The LCD device of claim 20, wherein the depth of said coupling light channel coincides with the distance from the light incident surface of said light guide plate to the luminous surface of said light bar; and said coupled light channel is directly connected to the light incident surface of said light guide plate.

22. The LCD device of claim 21, wherein the end width of said coupling light channel is less than or equal to the thickness of said light guide plate.

23. The LCD device of claim 22, wherein the width of the luminous surface of said light bar is less than the thickness of said light guide plate, the beginning opening of said coupling light channel is smaller than the end opening thereof, and the cross section of the coupling light channel is in a cone-shape.

24. The LCD device of claim 22, wherein the width of the luminous surface of said light bar is greater than the thickness of said light guide plate, the beginning opening of said coupling light channel is bigger than the end opening thereof, and the cross section of said coupling light channel is in an inverted cone-shape.

25. The LCD device of claim 18, said light bar comprises multiple light emitting lamps arranged side by side; and said coupling light element has multiple coupling light channels corresponding to each luminous surface of said light emitting lamp.

26. The LCD device of claim 18, wherein said light bar comprises multiple light emitting lamps arranged side by side, and each light emitting lamp is provided with one corresponding coupling light element.

27. The LCD device of claim 18, wherein the interior surface of said coupling light channel is a smooth reflecting surface.

28. The LCD device of claim 27, wherein said smooth reflecting surface is a curved surface that can lead the rays to the light incident surface of the light guide plate.

29. The LCD device of claim 27, wherein the interior surface of said coupling light channel is polished.

30. The LCD device of claim 18, wherein said coupling light element is installed on said light bar in the production process of said light bar.

31. The LCD device of claim 30, wherein said light bar comprises multiple light emitting lamps arranged side by side and a PCB board for mounting the light emitting lamps; and said coupling light element is installed on the package of said light emitting lamps.

32. The LCD device of claim 30, wherein said light bar comprises multiple light emitting lamps arranged side by side and the PCB board for mounting said light emitting lamps; said coupling light element is installed on the PCB board of said light bar; said coupling light element is provided with a mounting hole that matches with the shape of said light emitting lamps; said mounting hole is connected to said coupling light channel; and the size of said mounting hole is greater than or equal to the area of the beginning opening of said coupling light channel.

33. The LCD device of claim 32, wherein said coupling light element corresponding to each light emitting lamp has a ladder-shaped groove; said mounting hole is the first level groove of said ladder-shaped groove; and said coupling light channel is the second level groove of said ladder-shaped groove.

34. The LCD device of claim 18, wherein said coupling light element is made of metal or plastic materials.
